(19) United States
(12) Patent Application Publication
(10) Pub. No.: US 2013/0307658 A1
(43) Pub. Date: Nov. 21, 2013

(54) TRANSFORMER

(71) Applicants: Yu-Chin LIN, TAOYUAN HSIEN (TW); Yu-Jen HUANG, TAOYUAN HSIEN (TW); Zhi-Liang ZHANG, TAOYUAN HSIEN (TW)

(72) Inventors: Yu-Chin LIN, TAOYUAN HSIEN (TW); Yu-Jen HUANG, TAOYUAN HSIEN (TW); Zhi-Liang ZHANG, TAOYUAN HSIEN (TW)

(73) Assignee: DELTA ELECTRONICS, INC., TAOYUAN HSIEN (TW)

(21) Appl. No.: 13/615,762

(22) Filed: Sep. 14, 2012

(30) Foreign Application Priority Data
May 16, 2012 (TW) 101117490

(51) Int. Cl. H01F 27/30

(52) U.S. Cl. 336/199

(57) ABSTRACT

A transformer includes a bobbin. The bobbin includes a base and a main body. The main body is disposed on the base. The main body has a channel passing through the main body. The channel has two openings. Each of the openings has a first center. The main body includes a first main body portion and a second main body portion respectively at two sides of a first plane that is parallel to the base and passes through the first centers. The second main body portion is connected between the first main body portion and the base. The first main body portion and the second main body portion are asymmetric and have different heights relative to the first plane.

This application claims priority to Taiwan Application Serial Number 101117490, filed May 16, 2012, which is herein incorporated by reference.

### BACKGROUND

1. Technical Field

The present disclosure relates to a transformer, and more particularly, to a horizontal-type transformer.

2. Description of Related Art

As technologies advance, more and more different types of household electrical appliances have been developed. However, each electrical appliance requires a different voltage and power, and so various kinds of transformers that provide different voltages and powers are needed. Currently, two different kinds of transformers are in use. One is a high-frequency transformer that typically is a switching mode power supply transformer. Another is a low-frequency transformer that is a common silicon steel transformer.

A known transformer includes a bobbin and an iron core assembly. Primary winding coils and secondary winding coils can be wound around the bobbin of the transformer. The iron core assembly is partially accommodated in the bobbin, and thus the electromagnetic induction coupling generated among the iron core assembly and the primary winding coils and the secondary winding coils can achieve the purpose of voltage conversion,

Currently, leakage inductance exists in every transformer. That is, the magnetic flux generated by the primary winding coil is not entirely coupled to the inductance generated by the secondary winding coil in every transformer. Therefore, a variety of ways are sought for reducing the leakage inductance to reduce power loss and increase the conversion efficiency of transformers. Moreover, such leakage inductance must used to satisfy resonance requirements, and so the leakage inductance must meet a certain standard requirement in order to realize the generation of good resonance. That is, the leakage inductance of every transformer must be adjusted to satisfy various requirements.

However, in line with trends in the electronics industry to make products that are compact in size, many in the field are endeavoring to design a transformer that, in addition to being low in cost, has the advantages of a reduced number of components and which occupies a small space, all without influencing original performance.

### SUMMARY

In order to solve the problems of the prior art, the disclosure provides an improved transformer. Assuming that it is required to reduce height and that performance can be changed by only a limited amount, the transformer is configured such that a main body of a bobbin is shifted downwardly toward a base of the bobbin, so as to achieve the purpose of reducing the overall height of the transformer. The disclosure provides a preferred range of height percentage that the main body of the transformer is shifted downwardly relative to the base without sacrificing performance, so as to strike an appropriate balance between the height and the performance of the transformer. In order to enable application to the bobbin which is reduced in height, the transformer of the disclosure must use an asymmetric iron core. Because the iron core of the disclosure is asymmetric, the iron core must be rotated relative to the bobbin to the correct orientation, so as to be assembled to the bobbin. Furthermore, in order to reduce errors when the iron core is assembled to the bobbin, the disclosure disposes a fool-proof mark on the asymmetric iron core to enable convenient recognition during assembly.

According to an embodiment of the disclosure, a transformer includes a bobbin. The bobbin includes a base and a main body. The main body is disposed on the base and has a channel passing through the main body. The channel has two openings. Each of the openings has a first center. The main body includes a first main body portion and a second main body portion respectively at two sides of a first plane that is parallel to the base and passes through the first centers. The first main body portion and the second main body portion are asymmetric relative to the first plane.

In an embodiment of the disclosure, the first main body portion has a first height in a direction perpendicular to the first plane, the second main body portion has a second height in the direction, and the second height is smaller than the first height.

In an embodiment of the disclosure, the main body further includes two abutted surfaces. Each of the openings is located at the corresponding abutted surface. The contour of each of the abutted surfaces is a part of a circle. The circle and the corresponding opening are concentric.

In an embodiment of the disclosure, a ratio of the second height relative to the radius of the circle is 80-90%.

In an embodiment of the disclosure, the main body further includes a winding groove surrounding the outer wall of the channel and located between the abutted surfaces.

In an embodiment of the disclosure, the transformer further includes an iron core. The iron core has a trough and a cylinder located at the bottom of the trough. The iron core is assembled to the main body by passing the cylinder through the corresponding opening and abutting the bottom of the trough against the corresponding abutted surface, so that a portion of the main body is engaged between the sidewall of the trough and the cylinder.

In an embodiment of the disclosure, the iron core has a bottom surface. When the iron core is assembled to the main body, the bottom surface is aligned with the base.

In an embodiment of the disclosure, the cylinder has a facet. The facet has a second center. The iron core includes first iron core portion and a second iron core portion respectively at two sides of a second plane that is parallel to the bottom surface and passes through the second center. The first iron core portion corresponds to the first main body portion. The second iron core portion corresponds to the second main body portion. The bottom surface is located at the second iron core portion. The first iron core portion and the second iron core portion are asymmetric and have different heights relative to the second plane.

In an embodiment of the disclosure, the iron core has a top surface, and the top surface has a fool-proof mark.

In an embodiment of the disclosure, the first main body portion has a first height in a direction perpendicular to the first plane. The second main body portion has a second height in the direction. A ratio of the thickness of the base relative to a height sum of the first height and the second height is 5-10%.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a perspective exploded view of a transformer according to an embodiment of the disclosure;

FIG. 2 is a front view of a bobbin in FIG. 1; and

FIG. 3 is a front view of an iron core in FIG. 1.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

An improved transformer is provided. Specifically, assuming that it is required to reduce height and that performance can be changed by only a limited amount, the transformer is configured such that a main body of a bobbin is shifted downwardly toward a base of the bobbin, so as to achieve the purpose of reducing the overall height of the transformer. The disclosure provides a preferred range of height percentage that the main body of the transformer is shifted downwardly relative to the base without sacrificing performance, so as to strike an appropriate balance between the height and the performance of the transformer. In order to enable application to the bobbin which is reduced in height, the transformer of the disclosure must use an asymmetric iron core. Because the iron core of the disclosure is asymmetric, the iron core must be rotated relative to the bobbin to the correct orientation, so as to be assembled to the bobbin. Furthermore, in order to reduce errors when the iron core is assembled to the bobbin, the disclosure disposes a fool-proof mark on the asymmetric iron core to enable convenient recognition during assembly.

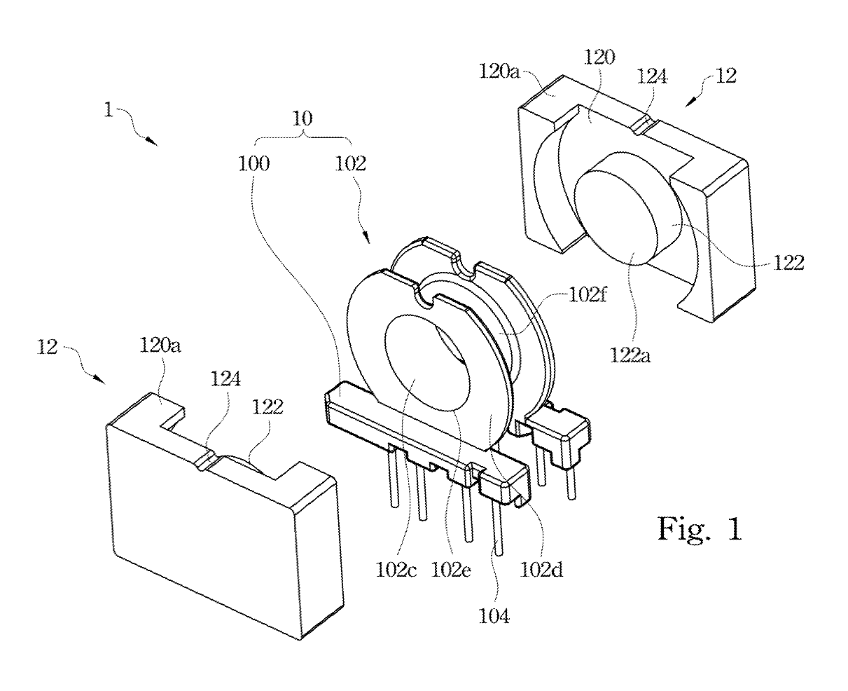

FIG. 1 is a perspective exploded view of a transformer 1 according to an embodiment of the disclosure.

As shown in FIG. 1, the transformer 1 of the disclosure can be a horizontal type transformer used in an adaptor, but the disclosure is not limited thereto. That is, the transformer 1 of the disclosure can be used in any electronic product that requires voltage transformation. Whenever height limitation conditions must be met during assembling, the concepts of the disclosure can be used to reduce the overall height of the transformer 1 without sacrificing performance.

As shown in FIG. 1, the transformer 1 includes a bobbin 10 and two iron cores 12. The structural configurations of the components included in the transformer 1 will be introduced in detail below.

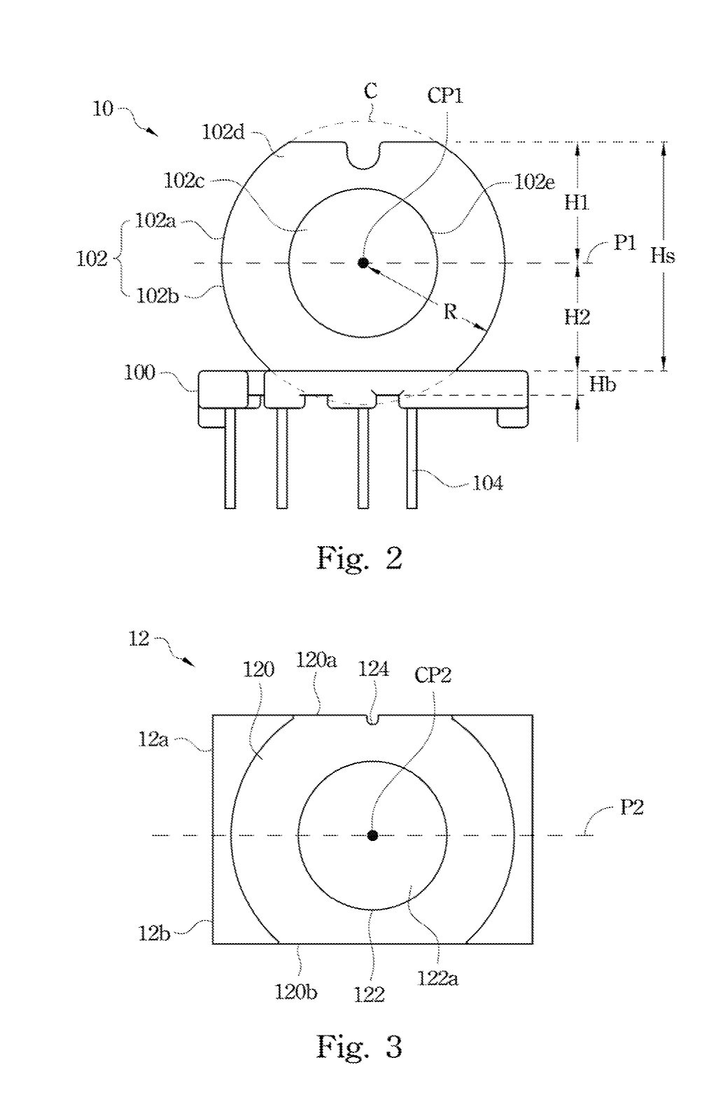

FIG. 2 is a front view of the bobbin 10 in FIG. 1.

As shown in FIG. 1 and FIG. 2, the bobbin 10 of the transformer 1 includes a base 100, a main body 102, and a plurality of pins 104. The main body 102 of the bobbin 10 is disposed on the base 100. The main body 102 of the bobbin 10 has a channel 102c. The channel 102c of the main body 102 passes through the main body 102. The channel 102c of the main body 102 has two openings 102e. Each of the openings 102e of the channel 102c has a first center CP1. The main body 102 of the bobbin 10 includes a first main body portion 102a and a second main body portion 102b respectively at two sides of a first plane P1 (i.e., the upper side and the lower side of the first plane P1 in FIG. 2) that is parallel to the base 100 and passes through the first centers CP1 of the openings 102e. The second main body portion 102b of the main body 102 is connected between the first main body portion 102a and the base 100. The first main body portion 102a and the second main body portion 102b of the main body 102 are asymmetric and have different heights relative to the first plane P1. The pins 104 of the bobbin 10 are disposed under the base 100.

In the embodiment of the disclosure, the first main body portion 102a of the main body 102 has a first height H1 in a direction perpendicular to the first plane P1. The second main body portion 102b of the main body 102 has a second height H2 in the direction perpendicular to the first plane P1. The second height H2 of the second main body portion 102b is smaller than the first height H1 of the first main body portion 102a. Compared with a conventional transformer including a first main body portion and a second main body portion that are symmetric and have the same height, the first main body portion 102a and the second main body portion 102b of the main body 102 are asymmetric relative to the first plane P1, and the second height H2 is smaller than the first height H1. That is, the main body 102 of the bobbin 10 is shifted downwardly toward the base 100, so as to achieve the purpose of reducing the overall height of the transformer 1.

As shown in FIG. 1 and FIG. 2, the main body 102 of the bobbin 10 further includes two abutted surfaces 102d. Each of the openings 102e of the channel 102c is located at the corresponding abutted surface 102d. The contour of each of the abutted surfaces 102d of the main body 102 is a part of a circle C (shown by the dotted line in FIG. 2), and the circle C and the corresponding opening 102e are concentric. In the embodiment of the disclosure, both the first height H1 of the first main body portion 102a and the second height H2 of the second main body portion 102b of the main body 102 are reduced. That is, a portion of the main body 102 located at the top of the circle C is removed (i.e., the portion indicated by the dotted line), and a portion of the main body 102 located at the bottom of the circle C is removed (i.e., the portion indicated by the dotted line). The base 100 is disposed in the area where the portion of the main body 102 located at the bottom of the circle C is removed.

With reference to FIG. 2, a ratio of the second height H2 of the second main body portion 102b relative to the radius R of the circle C is 80-90%. For example, if the radius R of the circle C is 9 mm, the second height H2 of the second main body portion 102b can be reduced to 7.2-8.1 mm, so as to shift downwardly the main body 102 of the bobbin 10 toward the base 100 and thus reduce the overall height of the transformer 1 without sacrificing performance. If the second height H2 of the second main body portion 102b is reduced to less than 7.2 mm, the channel 102c of the main body 102 and the base 100 will overlap, thus influencing the performance of the transformer 1. Accordingly, the lower limit value of the ratio of the second height H2 of the second main body portion 102b relative to the radius R of the circle C is 80%.

FIG. 3 is a front view of one of the iron cores 12 in FIG. 1.

As shown in FIG. 1 and FIG. 3, each of the iron cores 12 has a trough 120 and a cylinder 122. The cylinder 122 of each of the iron cores 12 is located at the bottom of the trough 122 (i.e., at an innermost wall of the iron core 12 defining the trough 120). Each of the iron cores 12 of the transformer 1 has a top surface 120a and a bottom surface 120b. In the embodiment of the disclosure, the sidewalls of the troughs 120 of the iron cores 12 are open at the top surface 120a and the bottom surface 120b. Each of the iron cores 12 can be assembled to the main body 102 of the bobbin 10 by passing the cylinder 122 through the corresponding opening 102e of the main body 102 and abutting the bottom of the trough 120 (i.e., the innermost wall of the iron core 12 defining the trough 120) against the corresponding abutted surface 102d, so that a portion of the main body 102 is engaged between the sidewall of the trough 120 and the cylinder 122. Meanwhile, the iron cores 12, which are respectively assembled at two sides of the bobbin 10 in the manner described above, abut against each other. Furthermore, when assembled to the main body 102 of the bobbin 10, the bottom surface 120b of each of the iron cores 12 of the transformer 1 is aligned with the base 100. The bottom surface 120b of each of the iron cores 12 can abut against the base 100, but such a configuration is not necessary.

As shown in FIG. 3, the cylinder 122 of each of the iron cores 12 has a facet 122a. The facet 122a of the cylinder 122 has a second center CP2. Each of the iron cores 12 includes a first iron core portion 12a and a second iron core portion 12b respectively at two sides of a second plane P2 (i.e., the upper side and the lower side of the second plane P2 in FIG. 3) that is parallel to the bottom surface 120b and passes through the second center CP2. Each of the first iron core portions 12a of the iron cores 12 corresponds to the first main body portion 102a of the main body 102. Each of the second iron core portions 12b of the iron cores 12 corresponds to the second main body portion 102b of the main body 102. The bottom surface 120b of each of the iron cores 12 is located at the second iron core portion 12b thereof. The first iron core portion 12a and the second iron core portion 12b of each of the iron cores 12 are asymmetric and have different heights relative to the second plane P2.

In order to comply with the asymmetric first main body portion 102a and the second main body portion 102b of the main body 102 of the bobbin 10, the first iron core portion 12a and the second iron core portion 12b of each of the iron cores 12 must correspondingly be asymmetric and have different heights.

As shown in FIG. 1 and FIG. 3, because each of the iron cores 12 of the disclosure is asymmetric, the each of the iron cores 12 must be rotated relative to the bobbin 10 to the correct the orientation thereof during assembly to the bobbin 10. In order to reduce errors when the iron cores 12 are assembled to the bobbin 10, the disclosure disposes a fool-proof mark 124 on the top surface 120a of each of the asymmetric iron cores 12. Therefore, assembly workers can visually recognize the fool-proof mark 124 on the top surface 120a of each of the iron cores 12, thus ensuring that assembly of the iron cores 12 to the main body 102 of the bobbin 10 occurs without error. In the embodiment of the disclosure, the fool-proof mark 124 on the top surface 120a of each of the iron cores 12 can be a notch, as shown in FIG. 3, but the disclosure is not limited in this regard.

As shown in FIG. 1, the main body 102 of the bobbin 10 further includes a winding groove 102f. The winding groove 102f of the main body 102 surrounds the outer wall of the channel 102c and is located between the abutted surfaces 102d. Primary winding coils and secondary winding coils (not shown) can be wound in the winding groove 102f of the main body 102. Therefore, after the iron cores 12 are assembled to the bobbin 10, the electromagnetic induction coupling generated among the iron cores 12 and the primary winding coils and the secondary winding coils that are wound in the winding groove 102f can achieve the purpose of voltage conversion.

In another embodiment of the disclosure, the first height H1 of the first main body portion 102a is smaller than the second height H2 of the second main body portion 102b. That is, the main body 102 of the bobbin 10 is not shifted downwardly toward the base 100, and the upper portion of the first main body portion 102a of the main body 102 is cut to reduce the first height H1, so as to achieve the same purpose of reducing the overall height of the transformer 1. A ratio of the thickness Hb of the base 100 relative to a height sum Hs of the first height H1 of the first main body portion 102a and the second height H2 of the second main body portion 102b is 5-10%. However, compared with this embodiment in which the upper portion of the first main body portion 102a of the main body 102 is cut to reduce the first height H1, the aforementioned embodiment in which the main body 102 of the bobbin 10 is shifted downwardly toward the base 100 (i.e., reducing the second height H2 of the second main body portion 102b) can achieve a higher utilization rate of winding copper window area. In other words, the disclosure reduce the second height H2 of the second main body portion 102b by sinking the main body 102 of the bobbin 10 toward the base 100 as shown in FIG. 1 and FIG. 2, so as to appropriately reduce the overall height of the transformer 1 without sacrificing performance as far as possible.

According to the foregoing recitations of the embodiments of the disclosure, it can be seen that assuming it is required to reduce height and performance can be changed by only a limited amount, the transformer is configured such that a main body of a bobbin is shifted downwardly toward a base of the bobbin, so as to achieve the purpose of reducing the overall height of the transformer. The disclosure provides a preferred range of height percentage that the main body of the transformer is shifted downwardly relative to the base without sacrificing performance, so as to strike an appropriate balance between the height and the performance of the transformer. In order to enable application to the bobbin which is reduced in height, the transformer of the disclosure must use an asymmetric iron core. Because the iron core of the disclosure is asymmetric, the iron core must be rotated relative to the bobbin to the correct orientation, so as to be assembled to the bobbin. Furthermore, in order to reduce errors when the iron core is assembled to the bobbin, the disclosure disposes a fool-proof mark on the asymmetric iron core to enable convenient recognition during assembly.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A transformer comprising:
a bobbin comprising:
a base; and
a main body disposed on the base and having a channel passing through the main body, the channel having two openings, each of the openings having a first center, wherein the main body includes a first main body portion and a second main body portion respectively at two sides of a first plane that is parallel to the base and passes through the first centers,
wherein the first main body portion and the second main body portion are asymmetric relative to the first plane.

2. The transformer of claim 1, wherein the first main body portion has a first height in a direction perpendicular to the first plane, the second main body portion has a second height in the direction, and the second height is smaller than the first height.

3. The transformer of claim 2, wherein the main body further comprises two abutted surfaces, each of the openings is located at the corresponding abutted surface, the contour of each of the abutted surfaces is a part of a circle, and the circle and the corresponding opening are concentric.

4. The transformer of claim 3, wherein a ratio of the second height relative to the radius of the circle is 80-90%.

5. The transformer of claim 3, wherein the main body further comprises a winding groove surrounding the outer wall of the channel and located between the abutted surfaces.

6. The transformer of claim 3, further comprising an iron core having a trough and a cylinder located at the bottom of the trough, wherein the iron core is assembled to the main body by passing the cylinder through the corresponding opening and abutting the bottom of the trough against the corresponding abutted surface, so that a portion of the main body is engaged between the sidewall of the trough and the cylinder.

7. The transformer of claim 6, wherein the iron core has a bottom surface, and when the iron core is assembled to the main body, the bottom surface is aligned with the base.

8. The transformer of claim 7, wherein the cylinder has a facet, the facet has a second center, the iron core includes a first iron core portion and a second iron core portion respectively at two sides of a second plane that is parallel to the bottom surface and passes through the second center, the first iron core portion corresponds to the first main body portion, the second iron core portion corresponds to the second main body portion, the bottom surface is located at the second iron core portion, and the first iron core portion and the second iron core portion are asymmetric and have different heights relative to the second plane.

9. The transformer of claim 6, wherein the iron core has a top surface, and the top surface has a fool-proof mark.

10. The transformer of claim 1, wherein the first main body portion has a first height in a direction perpendicular to the first plane, the second main body portion has a second height in the direction, and a ratio of the thickness of the base relative to a height sum of the first height and the second height is 5-10%.
